(19) United States
(12) Patent Application Publication
(10) Pub. No.: US 2017/0072875 A1
(43) Pub. Date: Mar. 16, 2017

(54) DATA COMMUNICATION METHOD FOR VEHICLE, ELECTRONIC CONTROL UNIT AND SYSTEM THEREOF

(71) Applicant: INFOBANK CORP., Seongnam-si (KR)

(72) Inventor: Jung Min KIM, Goyang-si (KR)

(21) Appl. No.: 14/919,898

(22) Filed: Oct. 22, 2015

(30) Foreign Application Priority Data
Sep. 14, 2015 (KR) 10-2015-0129824

(51) Int. Cl. B60R 16/023; H04L 29/06; H04L 9/06; H04H 20/12

(52) U.S. Cl. CPC B60R 16/023; H04H 20/12; H04L 63/0876; H04L 63/123; H04L 63/166; H04L 63/0853; H04L 9/0631

(57) ABSTRACT

Provided are a data communication method for a vehicle, an electronic unit and a system thereof, and the method includes: receiving the data for the vehicle; receiving a message authentication value; decoding the received data for the vehicle by using a counter value shared with a control unit at a transmitting side after authenticating the received message authentication value; and designating a counter value to be used later and transmitting the designated counter value to the control unit at the transmitting side when the decoding is unsuccessful.

### TECHNICAL FIELD

The present invention relates to a communication method between electronic control units (ECUs) which are electronic control units in a vehicle.

### BACKGROUND ART

In recent years, a vehicle technology has been developed by taking the focus on safety, user convenience, providing various services through communication with apparatuses in other fields, and the like in addition to an intrinsic function of a vehicle.

As a result, the number of electronic control units (ECUs) which are electronic control units installed in the vehicle has rapidly increased and the communication between the ECUs has been achieved through control area networks (CANs).

In recent years, with the attempt to provide various services in the vehicle, data for controlling the vehicle and important data such as personal information of a driver can be transmitted and received through the CAN.

Further, as networks used in the vehicle, a local interconnect network (LIN), FlexRay, and media oriented systems transport (MOST) are used in addition to the CAN and a gateway ECU is used for interworking of a communication protocol among other networks.

Among them, the CAN has an advantage to be resistant to external electromagnetic waves or noise due to a physical characteristic thereof and has the largest percentage of the communication networks in the vehicle due to the characteristic.

However, the CAN has several weak points in a security aspect and in particular, a third-party enterprise autonomously diagnoses the vehicle by communication with the CAN through an on board diagnostics (OBD-2) terminal or provides a product that provides user convenience by processing data of the CAN.

### SUMMARY OF THE INVENTION

The present invention has been made in an effort to provide a data communication method for a vehicle and an electronic control unit for a vehicle using the same which can strength security and improve communication efficiency in communication among ECUs which are electronic control units in the vehicle.

An exemplary embodiment of the present invention provides a communication method for transmitting data for a vehicle between control units in a vehicle with a plurality of control units, including: receiving the data for the vehicle; receiving a message authentication value; decoding the received data for the vehicle by using a counter value shared with a control unit at a transmitting side after authenticating the received message authentication value; and designating a counter value to be used later and transmitting the designated counter value to the control unit at the transmitting side when the decoding is unsuccessful.

Another exemplary embodiment of the present invention provides a control device for a vehicle which may perform the data communication method for the vehicle and the data communication method for the vehicle may be implemented by a computer readable recording medium having a program recorded therein to be executed in a computer.

Yet another exemplary embodiment of the present invention provides a communication system for transmitting data for a vehicle between control units in a vehicle with a plurality of control units, including: a first control unit encoding the data for the vehicle by using a counter value and an encoding key and generating a message authentication value by the encoded data for the vehicle by using an authentication key to broadcast the encoded data for the vehicle and the generated message authentication value; and a second control unit receiving the data for the vehicle and the message authentication value, decoding the received data for the vehicle by using the counter value and the encoding key after authenticating the received message authentication value, and designating a counter value to be used later when the decoding is unsuccessful and transmitting the designated counter value to the first control unit.

According to exemplary embodiments of the present invention, when decoding data for a vehicle is unsuccessful due to malicious message transmission from the outside such as a hacker, and the like in transmitting and receiving the data for the vehicle among control devices in the vehicle by using a controller area network (CAN) protocol, and the like, a control device at a receiving side designates a counter value to be used for encoding/decoding the data for the vehicle to allow the control devices to share the data, and as a result, stable communication in the vehicle can performed by effectively coping with external intrusion which occurs in data communication for the vehicle.

### BRIEF DESCRIPTION OF THE DRAWINGS

FIG. 1 is a block diagram illustrating a schematic configuration of a data communication system for a vehicle according to an exemplary embodiment of the present invention.

FIG. 2 is a timing diagram illustrating one example of a method for transmitting and receiving data for a vehicle among control units in the vehicle.

FIG. 3 is a diagram for describing one example of a situation in which a message is received from an external apparatus in the data communication system for the vehicle according to the exemplary embodiment of the present invention.

FIG. 4 is a flowchart illustrating a data communication method for a vehicle according to an exemplary embodiment of the present invention.

FIG. 5 is a diagram for describing an exemplary embodiment of a method for coping with an external hacking attempt in the data communication system for the vehicle according to the present invention.

### DETAILED DESCRIPTION

Hereinafter, a data communication method for a vehicle, an electronic control unit and a system thereof according to exemplary embodiments of the present invention will be described in detail with reference to the accompanying drawings.

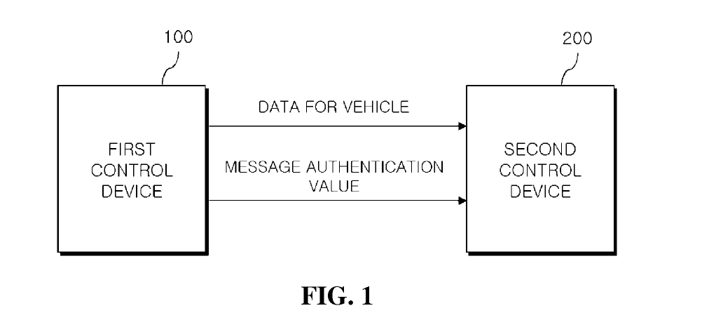

FIG. 1 is a block diagram illustrating a schematic configuration of a data communication system for a vehicle according to an exemplary embodiment of the present invention and the illustrated system may be configured to include a plurality of control devices 100 and 200 provided in the vehicle.

Referring to FIG. 1, the first control device 100 may transmit data for the vehicle and the transmitted data for the vehicle may be encoded for security. Further, the first control device 100 may transmit a message authentication value for authenticating the data for the vehicle together with the data for the vehicle.

Meanwhile, the second control device 200 receives the data for the vehicle and the message authentication value transmitted from the first control device 100 and authenticates the received message authentication value to decode and acquire the received data for the vehicle when being successful in authenticating the message authentication value.

The plurality of control devices 100 and 200 provided in the vehicle may be electronic control units (ECUs) which are electronic control units provided in the vehicle and the ECUs performs mutual communication by using protocols used in the vehicle.

The protocols used for the communication among the ECUs in the vehicle include controller area network (CAN), local interconnect network (LIN), FlexRay, media oriented systems transport (MOST), and the like and in the present invention, the data for the vehicle may mean a message generated by using any one of the protocols.

As the CAN protocol among the communication protocols in the vehicle is constituted by a pair of twisted lines, the CAN protocol has an advantage to be resistant to external electronic waves or noise due to a physical characteristic and has a characteristic suitable for a vehicle environment by using a broadcast communication scheme.

However, since a communication scheme using the CAN protocol uses broadcast communication, it is easy to wiretap a network from the outside and there is a system that may authenticate the transmitted and received message.

Further, since the CAN protocol does not encode the transmitted and received message, it is difficult to prevent the message from being forged or falsificated during transmission and reception and it is also difficult to prevent a message retransmission attack in which an external attacker retransmits a message acquired through wiretapping to the ECU to the ECU as it is.

According to the exemplary embodiment of the present invention, as described with reference to FIG. 1, the first control device 100 which is the ECU at a transmitting side encodes and broadcasts the data for the vehicle and transmits the message authentication value for authenticating the broadcasted data for the vehicle to reduce a risk of wiretapping, forging, or falsification using the CAN protocol.

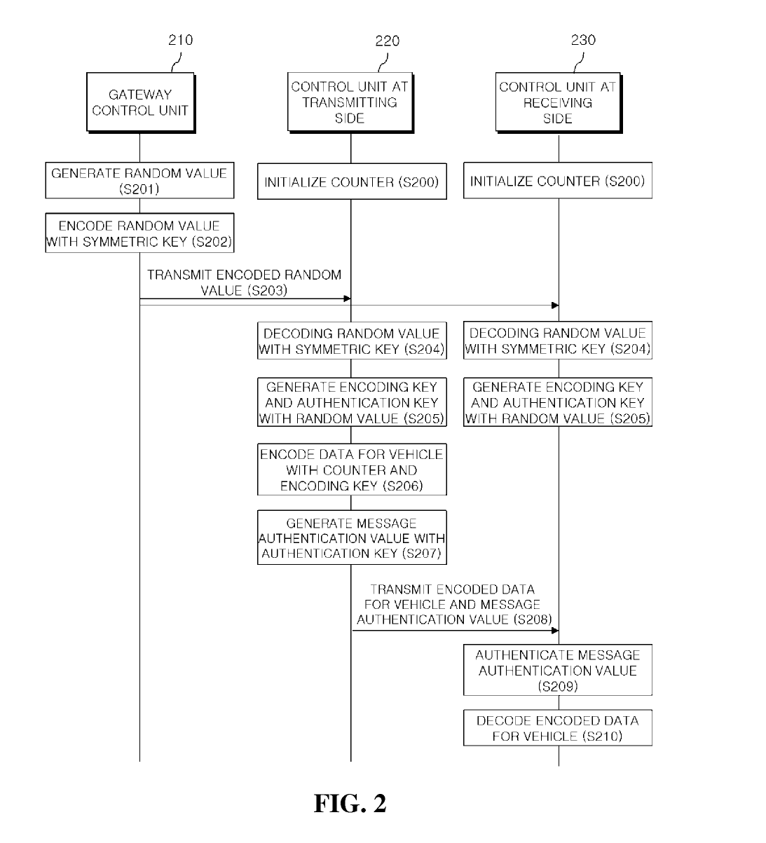

FIG. 2 is a timing diagram illustrating one example of a method for transmitting and receiving data for a vehicle among control units in the vehicle.

Referring to FIG. 2, a gateway control unit 210 stores a unique certificate issued from an authorized authority and a symmetric key for sharing with control units included in the corresponding network and each of control units 220 and 230 provided in the vehicle may also store a symmetric key which is the same as the symmetric key stored by the gateway control unit 210.

Herein, the gateway control unit 210 means a gateway ECU provided in the vehicle and the control units 220 and 230 may mean the ECUs provided in the vehicle, respectively.

Further, only the control unit 220 at the transmitting side and the control unit 230 at the receiving side are illustrated in FIG. 2, but more control units are provided in the vehicle in addition to the control units 220 and 230 illustrated in FIG. 2 and a message broadcasted from the gateway control unit 210 or any one control unit may be received by all control units provided in the vehicle.

The control units 220 and 230 provided in the vehicle initialize and share a counter value to be used for encoding and decoding the data for the vehicle with each other (step S200) and the gateway control unit 210 generates a random value to be used for an authentication key and an encoding key (step S201).

Thereafter, the gateway control unit 210 encodes the generated random value by using the symmetric key (step S202) and transmits the encoded random value to all control units 220 and 230 provided in the vehicle, which are connected in the network.

The control units 220 and 230 that receive the random value encoded with the symmetric key decode the encoded random value by using prestored symmetric keys, respectively (step S204) and generate the encoding key and the authentication key by using the decoded random value (step S205).

Thereafter, the control unit 220 at the transmitting side, which intends to transmit the data for the vehicle encodes the data for the vehicle by using the counter value shared with other control units and the encoding key generated in step S205 (step S206) and generates the message authentication value by using the authentication generated in step S205 (step S207).

For example, the control unit 220 at the transmitting side encodes the counter value initialized in step S200 and thereafter, performs an exclusive operation (Xor) with the data for the vehicle to be transmitted to acquire the encoding message.

Further, the control unit 220 at the transmitting side may generate a message authentication value having a size of 128 bits, which includes the encoding message by using the authentication key and insert higher 64 bits among 128 bits into a network packet to transmit the authentication value.

Thereafter, the control unit 220 at the transmitting side broadcasts the encoded data for the vehicle and message authentication value and transmits the broadcasted data for the vehicle and message authentication value to the control unit 230 at the receiving side (step S208).

Meanwhile, the control unit 220 at the transmitting side may increase the counter value thereof by 1 when the encoding of the data for the vehicle and the generation of the message authentication value are completed and the encoded data for the vehicle and the generated message authentication value are transmitted.

The control unit 230 at the receiving side receives the encoded data for the vehicle and message authentication value transmitted from the control unit 220 at the transmitting side to first authenticate the message authentication value (step S209) and when the authentication is successful, the control unit 230 at the receiving side decodes the data for the vehicle by using the encoded key shared between the control units 220 and 230 and the counter value (step S210).

For example, the control unit 230 at the receiving side may verify an ID field in the network packet broadcasted and received from the control unit 220 at the transmitting side and thereafter, authenticate the message authentication value included in the network packet by using the authentication key.

When authenticating the message authentication value is completed, the control unit 230 at the receiving side decodes the encoding message in the received network packet by using the encoding key and the counter value to acquire the data for the vehicle.

As described above, the control unit 230 at the receiving side, which acquires the data for the vehicle increases the counter value thereof by 1, and as a result, the counter values of the control unit 220 at the transmitting side and the control unit 230 at the receiving side coincide with each other to be maintained.

The method for transmitting and receiving the data for the vehicle between the control units in the vehicle, which is described with reference to FIG. 2 is just one example for describing the data communication method for the vehicle according to the present invention and the present invention is not limited thereto.

For example, the gateway control unit 210 may generate a random value and a secret value and transmit the generated random value and secret value to the control unit 220 and 230 provided in the vehicle an the control units 220 and 230 may generate a first session key and a second session key by using the secret key.

Meanwhile, the control units 220 and 230 may transmit an encoding text and a first message authentication code by using the generated first session key and second session key and transmit the generated encoding text and first message authentication code to the gateway control unit 210 and the gateway control unit 210 verify the generation of the first session key and the second session key of the corresponding control unit from the received encoding text and first message authentication code.

Thereafter, the control unit 220 at the transmitting side may generate the encoded data for the vehicle and a second message authentication code and transmit the network packet to be transmitted, which includes the encoded data for the vehicle and the second message authentication code to the control unit 230 at the receiving side.

The control unit 230 at the receiving side authenticates the second message authentication code included in the received network packet and thereafter, decodes the encoded data for the vehicle to acquire the data for the vehicle.

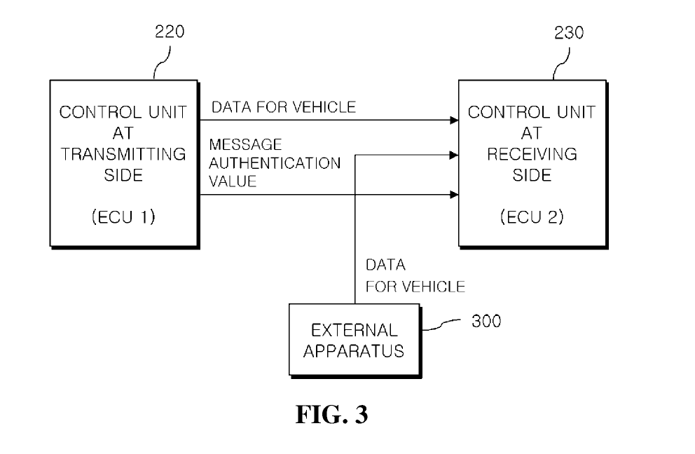

Referring to FIG. 3, a situation may occur, in which the message is received from the external apparatus in the data communication system for the vehicle according to the exemplary embodiment of the present invention.

For example, after the control unit 220 at the transmitting side transmits the encoded data for the vehicle, before the message authentication value is transmitted, a malicious message may be transmitted from an external apparatus 300 in the form of the data for the vehicle depending on the CAN protocol, and the like in the meantime and received by the control unit 230 at the receiving side.

In this case, the control unit 230 at the receiving side may fail in decoding as the counter values or the encoding keys do not coincide with each other in authenticating the message authentication value and thereafter, decoding the previously received data for the vehicle by the method described with reference to FIGS. 1 and 2.

Meanwhile, when the control unit 230 at the receiving side succeeds in decoding the encoded data for the vehicle, the control unit 230 at the receiving side increases the counter value by 1, but when the control unit 230 at the receiving side fails in decoding, the control unit 230 at the receiving side does not increase the counter value, and as a result, the counter value increased by 1 after the control unit 220 at the transmitting side transmits the encoded data for the vehicle and message authentication value and the counter value of the control unit 230 at the receiving side do not coincide with each other.

When the counter values shared by the control unit 220 at the transmitting side and the control unit 230 at the receiving side do not coincide with each other, the control unit 230 at the receiving side may not decode the subsequently transmitted and received data for the vehicle.

That is, the counter values may not coincide with each other as the message transmitted by the control unit 220 at the transmitting side and the malicious message of the hacker may not be distinguished from each other only by authenticating the message authentication value when CAN messages generated by the hacker are continuously broadcasted to be received by the control unit 230 at the receiving side between the data for the vehicle and the message authentication value.

In more detail, when the encoded data for the vehicle and message authentication value are transmitted by the same CAN ID, in the case where an intrusion message transmitted from the external apparatus 300 by the hacker, and the like at the time similar to the transmission time of the encoded data for the vehicle has the same CAN ID thereas, when the control unit 230 at the receiving side authenticates and verifies the message by the method described with reference to FIGS. 1 and 2, the instruction message and the message transmitted from the control unit 220 at the transmitting side are together discarded and the counter values do not coincide with each other as described above.

Further, even when the encoded data for the vehicle and message authentication value are transmitted by another CAN ID, in the case where the malicious encoded message and the message authentication value are transmitted by the hacker, and the like at the time similar to the transmission time of the encoded data for the vehicle, additional operations of comparing all encoded messages and authentication values, and the like are required in the control unit 230 at the receiving side.

In addition, even in the case where the control unit 230 at the receiving side may not receive the message transmitted by the control unit 220 at the transmitting side due to an instantaneous hardware problem, and the like, the counter values do not coincide with each other as described above.

According to the exemplary embodiment of the present invention, when decoding the data for the vehicle is unsuccessful due to malicious message transmission from the outside such as the hacker, and the like in transmitting and receiving the data for the vehicle among the control devices in the vehicle by using a controller area network (CAN) protocol, and the like, a control device at a receiving side designates a counter value to be used for encoding/decoding the data for the vehicle to allow the control devices to share the data, and as a result, stable communication in the vehicle may be performed by effectively coping with external intrusion which occurs in data communication for the vehicle.

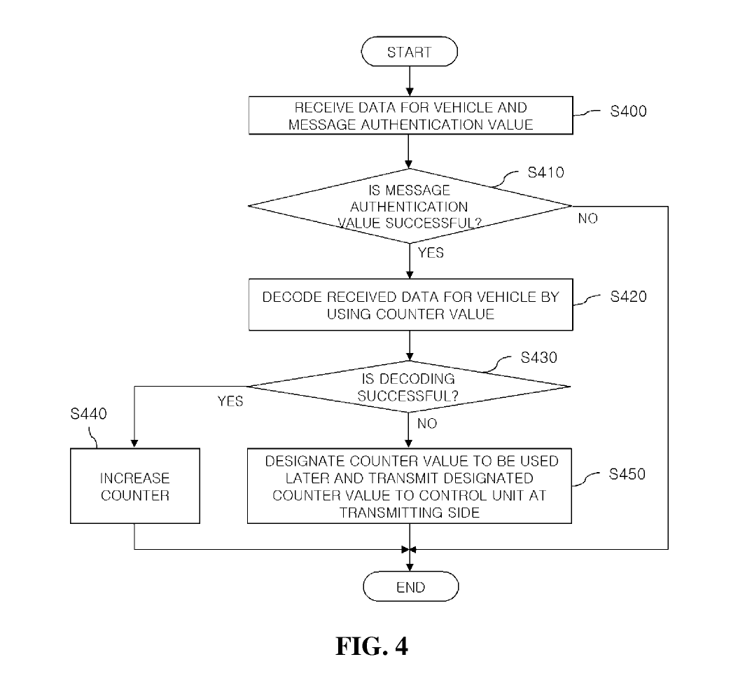

FIG. 4 is a flowchart illustrating a data communication method for a vehicle according to an exemplary embodiment of the present invention and description of the method which is the same as the method described with reference to FIGS. 1 to 3 among the communication methods will be hereinafter omitted.

Referring to FIG. 4, the control unit 230 at the receiving side receives data for the vehicle and a message authentication value transmitted from the control unit 220 at the transmitting side (step S400).

Thereafter, the control unit 230 at the receiving side authenticate the received message authentication value and when the authentication is successful (step S410), the control unit 230 at the receiving side decodes the received data for the vehicle by using a counter value shared with the control unit 220 at the transmitting side (step S420).

As described above, the data for the vehicle may be a message broadcasted by using the CAN protocol and to this end, the control units 220 and 230 may generate an encoding key for encoding/decoding the data for the vehicle and an authentication key for authenticating the message authentication value by using a random value received from the gateway control unit 210.

Further, the data for the vehicle may be an encoding message generated by using the counter value shared by the control units 220 and 230 and the encoding key and the encoding message may be generated as a message authentication value having a predetermined size by using the authentication key.

Meanwhile, the data for the vehicle, which is received in step S400 may be a message maliciously intruded by the hacker, and the like as described with reference to FIG. 3 and in such a case, decoding the received data for the vehicle is unsuccessful, and as a result, the counter values of the control units 220 and 230 may not coincide with each other.

When decoding the encoded data for the vehicle is successful (step S430), the control unit 230 at the receiving side acquires the data for the vehicle and increases the counter value by 1 (step S440).

Unlike this, when decoding the encoded data for the vehicle is successful (step S430), the control unit 230 at the receiving side designates a counter value to be used later and transmits the designated counter value to the control unit 220 at the transmitting side (step S450).

In this case, the control unit 220 at the transmitting side resets the counter value to be used for encoding or decoding later as the counter value transmitted from the control unit 230 at the receiving side in step S450 to stably cope with the situation in which the counter values do not coincide with each other.

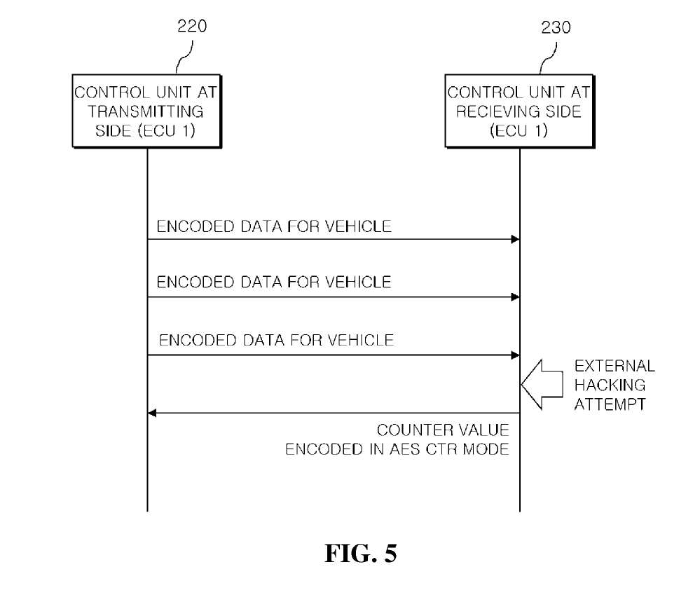

Referring to FIG. 5, in a situation in which the control unit 220 at the transmitting side periodically broadcasts the encoded data for the vehicle as the CAN message, when a malicious CAN message is intruded by an external hacking attempt and received by the control unit 230 at the receiving side in the middle, the control unit 230 at the receiving side may designates the counter value to be used for decoding later and encodes the designated counter value in an AES CTR mode and thereafter, transmit the counter value as the CAN message.

The control unit 230 at the receiving side encodes and transmits the counter value to be used for decoding later in the AES CTR mode as described above, and as a result, the counter values of the control units 220 and 230 may not coincide with each other while maintaining security of the counter value for the outside.

The data communication method for the vehicle according to the present invention is prepared as a program to be executed in a computer to be stored in a computer-readable recording medium and an example of the computer readable medium may include a read only memory (ROM), a random access memory (RAM), a compact disk read only memory (CD-ROM), a magnetic tape, a floppy disk, an optical data storage, or the like, and also include a medium implemented in a form of a carrier wave (for example, transmission through the Internet).

The computer readable recording media are distributed on computer systems connected through the network, and thus the computer-readable recording media may be stored and executed as the computer-readable code by a distribution scheme. Further, functional programs, codes, and code segments for implementing the method may be easily inferred by a programmer in a technical field to which the present invention belongs.

While the exemplary embodiments of the present invention have been illustrated and described above, the present invention is not limited to the aforementioned specific exemplary embodiments, various modifications may be made by a person with ordinary skill in the technical field to which the present invention pertains without departing from the subject matters of the present invention that are claimed in the claims, and these modifications should not be appreciated individually from the technical spirit or prospect of the present invention.

What is claimed is:

1. A communication method for transmitting data for a vehicle between control units in a vehicle with a plurality of control units, the communication method comprising:
receiving the data for the vehicle;
receiving a message authentication value;
decoding the received data for the vehicle by using a counter value shared with a control unit at a transmitting side after authenticating the received message authentication value; and
designating a counter value to be used later and transmitting the designated counter value to the control unit at the transmitting side when the decoding is unsuccessful.

2. The communication method of claim 1, wherein the data for the vehicle is a message broadcasted by using a controller area network (CAN) protocol.

3. The communication method of claim 1, further comprising:
generating an encoding key for encoding/decoding the data for the vehicle and an authentication key for authenticating the message authentication value by using a random value received from a gateway control unit.

4. The communication method of claim 3, wherein the data for the vehicle is generated by performing an exclusively operation (Xor) with a counter value encoded with the encoding key.

5. The communication method of claim 3, wherein the message authentication value is generated as a code having a predetermined size by using the authentication key.

6. The communication method of claim 1, wherein the data for the vehicle is broadcasted from an external apparatus other than a plurality of control units provided in the vehicle.

7. The communication method of claim 6, further comprising:
before the receiving of the data for the vehicle,
receiving the encoded data for the vehicle, which is broadcasted from the control unit at the transmitting side.

8. The communication method of claim 1, further comprising:
increasing the counter value when the decoding is successful.

9. The communication method of claim 1, wherein in the transmitting, the designated counter value is encoded and broadcasted by using an AES CTR mode.

10. A control device for a vehicle, which performs the communication method of claim 1.

11. A communication system for transmitting data for a vehicle between control units in a vehicle with a plurality of control units, the communication system comprising:
a first control unit encoding the data for the vehicle by using a counter value and an encoding key and generating a message authentication value by the encoded data for the vehicle by using an authentication key to broadcast the encoded data for the vehicle and the generated message authentication value; and
a second control unit receiving the data for the vehicle and the message authentication value, decoding the received data for the vehicle by using the counter value and the encoding key after authenticating the received message authentication value, and designating a counter value to be used later when the decoding is unsuccessful and transmitting the designated counter value to the first control unit.

12. The communication system of claim 11, further comprising:
a gateway control unit transmitting random values to a plurality of control units including the first and second control units,
wherein each of the plurality of control units generates and stores the encoding key and the authentication key by using the random value received from the gateway control unit.

13. The communication system of claim 11, wherein the second control unit receives the data for the vehicle, which is broadcasted from an external apparatus other than the plurality of control units between the encoded data for the vehicle and the message authentication value broadcasted from the first control unit.

14. The communication system of claim 11, wherein the second control unit encodes and broadcasts the designated counter value by using an AES CTR mode.
